(19) United States
(12) Patent Application Publication
(10) Pub. No.: US 2002/0103682 A1
(43) Pub. Date: Aug. 1, 2002

(54) Balance sheet and method for measuring intellectual capital

(76) Inventors: Donna M. Stemmer, Plano, TX (US); Mike Gardner, Oakwood (GB); Corey W. Wick, Plano, TX (US)

Correspondence Address: BAKER BOTTS L.L.P., 2001 ROSS AVENUE, SUITE 600, DALLAS, TX, 75201-2980, US

(21) Appl. No.: 10/029,657

(22) Filed: Dec. 20, 2001

Related U.S. Application Data
(60) Provisional application No. 60/257,676, filed on Dec. 22, 2000.

(51) Int. Cl. G06F 17/60

(52) U.S. Cl. 705/7

(57) ABSTRACT

A balance sheet and method for measuring intellectual capital includes identifying one or more intellectual capitals to be measured, wherein the intellectual capital comprises human capital, structural capital, and external capital. A set of metrics that are present within the identified intellectual capitals are selected. Values are assigned to the set of selected metrics. The set of valued metrics are scaled, wherein the scaled metrics are operable to be mathematically associated. The identified intellectual capitals are quantified based on the scaled metrics.

### RELATED APPLICATIONS

This application claims the priority under 35 U.S.C. §119 of provisional application serial No. 60/257,676 filed Dec. 22, 2000.

### TECHNICAL FIELD OF THE INVENTION

The present invention relates generally to measuring market value and, more particularly, to a balance sheet and method for measuring intellectual capital.

### BACKGROUND OF THE INVENTION

Businesses today are showing large discrepancies between their market price and their financial assets (as defined in their financial balance sheet). Many businesses have share values that considerably outweigh their physical or financial assets. In essence, the market realizes that the value of a company involves far more than its financial assets.

A business's market value includes its financial capital and its intellectual capital. Financial capital is controlled by traditional accounting practices and standards. However, intellectual capital, which is a significant percentage of a business's market value, is typically undefined and unmanaged.

In a study by Karl Erik Sveiby, as discussed in his book “The New Organizational Wealth,” it was determined that businesses that used intellectual capital outperformed their peers in value creation by a margin of 50 percent. Karl Erik Sveiby, The New Organizational wealth, Berrtt-Koehler (1988). The business's shareholder value increased at an average annual rate of 22.2 percent, compared with 14.7 percent for companies focused solely on profit growth and negative 1 percent for businesses seeking revenue growth. Id. at 8. The study also found that a balanced strategy produced increased revenue growth by an average annual rate of 19.2 percent, higher than the 14.6 percent annual rate for businesses actually practicing a revenue growth strategy. Id. at 8.

### SUMMARY OF THE INVENTION

The present invention provides a system and method for measuring intellectual capital that address problems and disadvantages with previous systems and methods. In a particular embodiment, the present invention uses intellectual capital benchmarking to enable a business to quantitatively measure it's intellectual capital.

In an example embodiment, method for measuring intellectual capital includes identifying one or more intellectual capitals to be measured, wherein the intellectual capitals comprise human capital, structural capital, and external capital. A set of metrics that are present within the identified intellectual capitals are selected. Values are assigned to the set of selected metrics. The set of valued metrics are scaled, wherein the scaled metrics are operable to be mathematically associated. The identified intellectual capitals are quantified based on the scaled metrics.

Technical advantages of one or more embodiments of the present invention include allowing a business or business unit to make balanced business decisions based on intellectual capital as well as financial capital. These balanced business decisions include increasing staff happiness and decreasing staff turnover through proper training and development. Other advantages include exploiting the benefits of a business's intellectual capital, meeting SEC organizational requirements, and increasing a business's share price. Furthermore, at least one embodiment of the present invention allows management personnel to further define the intellectual property of the business.

The various embodiments of the present invention may each include some, all, or none of the aforementioned technical advantages. Other technical advantages of the present invention will be readily apparent to one skilled in the art from the following figures, description, and claims.

### BRIEF DESCRIPTION OF THE DRAWINGS

For a more complete understanding of the present invention and its advantages, reference is now made to the following descriptions, taken in conjunction with the accompanying drawings, in which:

FIG. 1 is a block diagram illustrating intellectual capitals in accordance with the prior art;

FIG. 2 is a block diagram illustrating categories of the intellectual capitals in accordance with one embodiment of the present invention;

FIG. 3 is a radar diagram illustrating a method of measuring intellectual capital in accordance with one embodiment of the present invention;

FIG. 4 is a radar diagram illustrating a method of measuring intellectual capital in accordance with one embodiment of the present invention; and

FIG. 5 is a flow diagram illustrating a method of measuring intellectual capital in accordance with one embodiment of the present invention.

### DETAILED DESCRIPTION OF THE INVENTION

FIG. 1 illustrates Intellectual Capital 25 in accordance with the prior art. Intellectual Capital 25 is knowledge having value to a business or business unit, including the tacit knowledge embedded in people, processes, and clients. The business's Market Value 15 is substantially the sum of Financial Capital 20 and Intellectual Capital 25. In one embodiment, Intellectual Capital 25 may be subdivided into Human Capital 30, Structural Capital 35, and External Capital 40. As an example, the value of the business's Intellectual Capital 25 might be a result of the data from Human Capital 30, Structural Capital 35, and External Capital 40. It will be understood that the term intellectual capital will include Intellectual Capital 25 and/or one or more of Human Capital 30, Structural Capital 35, and External Capital 40.

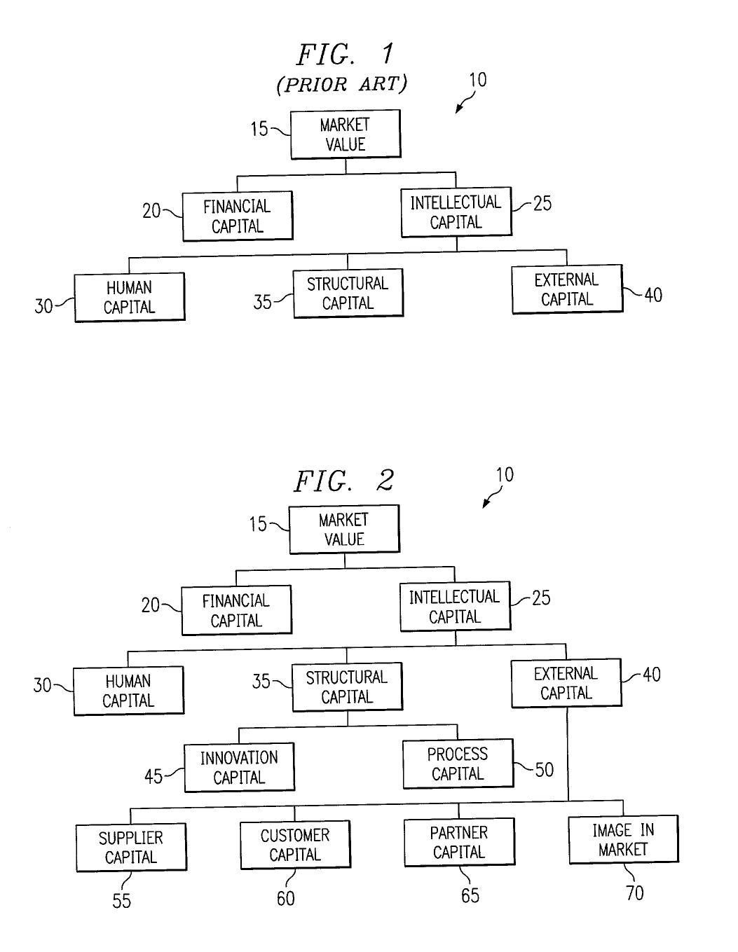

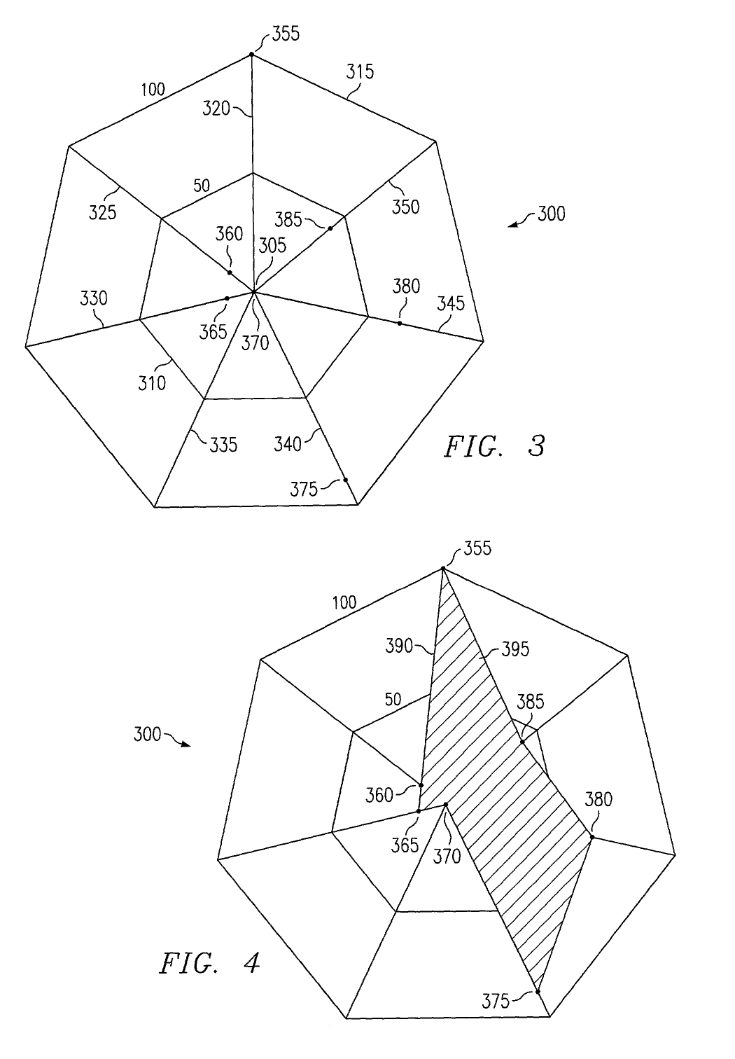

FIG. 2 illustrates the sub-categories of the intellectual capitals of FIG. 1 in accordance with one embodiment of the present invention.

Human Capital 30 includes the capabilities of individuals required to provide solutions to customers. In one embodiment, Human Capital 30 refers to the knowledge, talents, expertise, and problem-solving ability of the business's or business unit's staff. It also might include measurements for experience, training, competence, and the leveragability and stability of the workforce. Furthermore, Human Capital 30 may refer to the size of the staffs' social networks. For example, the social network may include professional relationships and the strength of those relationships. In another example, the business might choose to quantify leadership qualities of its management team. This may include assigning a value to leadership skills. It will be understood that some types of knowledge and expertise are tacit. Human Capital 30 measurements might be an indicator of the business's ability to generate innovative solutions to complex problems. It will be understood that there may be additional reasons to quantify the business's Human Capital 30.

Structural Capital 35 includes the experience and expertise of the organization embedded in processes, policies and systems, such as codification/transfer of knowledge and enabling infrastructure. Structural Capital 35 may include intellectual structural capital and tangible structural capital. Intellectual structural capital is generally considered to be distinct from tangible structural capital, which may include such things as property, plant, and equipment. Structural Capital 35 might represent the quality and revenue-producing capability of the business's processes, procedures, and practices. Structural Capital 35 might add value to the abilities and productivity of its personnel. For example, a recent college graduate working might be more valuable and productive than at a business with less Structural Capital 35 (a start-up business, for example). Structural capital might be explicit and contained within intellectual assets.

External Capital 40 includes the value of the business's relationships with other entities such as, for example, other companies with whom it does business. This might include understanding customer and supplier visions, values and requirements. In one embodiment, External Capital 40 is quantified by the value added to the business from external sources. For example, the business's brand image, or its reputation among current and potential customers and suppliers, might allow the business to command higher premiums for its services. The business's customers and suppliers and the strength and length of the relationships might reflect the long-term viability of the business.

Structural Capital 35 includes Innovation Capital 45 and Process Capital 50. Innovation Capital 45 may include the value of intellectual property, such as patents, licenses and royalty streams, and the value of seminars hosted by the business or business unit. In one embodiment, Process Capital 50 is a quantification of knowledge being passed around the business. Process Capital 50 may include the business's investment in internal structures, including IT and other knowledge-sharing facilities, and volume of email transmitted internally.

External Capital 40 includes Supplier Capital 55, Customer Capital 60, Partner Capital 65, and Image in Market 70. Supplier Capital 55 may include the satisfaction of the supplier, customer satisfaction with the supplier, and the business's satisfaction with the supplier. Each of these may be measured and scaled to represent one median number. For example, a poll may be sent to the business customers in regards to a supplier resulting in a satisfaction index that may be compared to a satisfaction index performed by the business's business units.

Customer Capital 60 may include competence enhancing customers, which may be a number of customers that receive a certain score on a series of questions posed to the business's staff. For example, one question may ask the staff member if the customer is willing to give referrals. Another question may attempt to determine if the customer provides high profit projects. Partner Capital 65 probably includes a partner satisfaction index or a satisfaction with partner index. Alternatively, Partner Capital 65 may include any other measure that might assist the business or business unit in assigning a value to Partner Capital 65. Image in Market 70 preferably includes market analysis ratings or the value of the business's trademarks. Alternatively, Images in Market may include any other measure capable of quantifying the business's Image in Market 70.

Each intellectual capital (Human Capital 30, Structural Capital 35, and External Capital 40), has associated metrics. A given metric may be any quantifiable indicator that may be measured through data gathering or some other method. Furthermore, the metric may be monetary or non-monetary. A monetary metric may include an indicator measured by a dollar value or some other financial measure. A non-monetary metric may include an indicator that is measured by time, volume, poll result, or any other non-financial measure. The metric may also be related to other metrics in order to determine a value for the respective intellectual capital. For example, a subset of metrics may be scaled to one another such that the subset can be represented in a radar diagram or other mathematical computation. An exemplary list of metrics for each intellectual capital and category is included below. It will be understood that the list is not exclusive and is for exemplary purposes only.

1.0 Human Capital 30 Metrics

1.1 Number of Communities of Interest/Affinity Groups Set Up may include a total of discussion groups within the business or business unit.

1.2 Relative Pay Position may include an index of staff pay to outside pay.

1.3 Competency Information

1.3.1 Experience in a Competency Type may include the total number of years for all staff members in the competency type.

1.3.2 Experience of Workforce may include the experience level of staff within the business.

1.4 Personal Performance of Staff

1.4.1 Staff Turnover may include the number of staff leaving the business divided by the total number of employees.

1.4.2 Median Age of Staff in Organization may include the median age of staff in the business or business unit employed during a period.

1.4.3 Succession Planning may include the percentage of managers who developed plans for their successors.

1.4.4 Revenue Generating Staff/Efficiency of Organization may include the number of professionals divided by the total number of staff.

1.4.5 Internal Grading may include the number of staff promoted during a period divided by the total number of staff.

1.4.6 Professional Internal Grading may include the median ratings given to staff by management or peers.

1.4.7 Timely Appraisals may include the number of staff members appraised during a period.

1.4.8 Number of Days Absenteeism may include the number of days absent divided by total number of work days for period.

1.4.9 Mentored Staff may include the number of staff with an assigned mentor/total number of staff.

1.4.10 Social Network Mapping may include the number of staff member contacts within a business unit.

1.4.11 Knowledge Sharer Performance may include the measure of how well a staff member shares knowledge with remaining staff.

1.4.12 Leverage Effect may include the calculation (profit/revenue)×(revenue/number of staff)×(number of staff/number of professional staff).

1.5 Training and Education

1.5.1 Training Investment may include the training costs spent on professionals divided by total revenues.

1.5.2 Education Level per Staff Member may include the median grade of education by staff.

1.5.3 Training Provided may include the number of hours training provided divided by the number of employees.

1.6 Staff Attitudes

1.6.1 Staff Satisfaction Survey may include the overall figure of staff satisfaction.

1.6.2 Staff Referrals may include the number of staff referrals divided by the number of staff positions filled for a period.

1.7 Work Related

1.7.1 Contractor Usage may include the numbers of contractors divided by the number of staff.

1.7.2 Revenue Generating Staff/Efficiency of Organization may include the number of professional staff divided by total number of staff.

1.7.3 Time Not Spent on Productive Work may include the percent of total staff time spent on non-productive work and total staff work time.

1.7.4 Value Added per Staff Member may include the how much value each professional contributes to the business, business unit, or a project.

1.8 Rookie Ratio may include the number of staff with less than two years experience divided by the total number of staff.

1.9 Open Plan Office Space may include the percentage of employees in an open office.

2.0 Innovation Capital 45 Metrics

2.1 Communication Internally

2.1.1 Best Practice Shared may include the number of best practices made available to staff.

2.1.2 Usage of Best Practices may include the number of best practices shared by staff members.

2.1.3 Usage of a Piece of Knowledge may include the number of times that a piece of data is retrieved from a repository.

2.1.4 New Ideas Generated may include the total number of ideas that staff present to management as new.

2.1.5 White Papers Published may include the total number of white papers published in a period.

2.2 Patent Protection

2.2.1 Number of Patents Owned may include the number of patents successfully applied for by the business.

2.2.2 Value of Patents Owned may include the licensing fees received for the patents owned by the business.

2.2.3 Number of Patents Proposed may include the total number of patent ideas suggested by staff, possibly including those not applied for.

2.3 Communication Externally

2.3.1 Published Internal Achievements may include the time spent by staff presenting to external seminars.

2.3.2 Words in Print may include the total number of words printed in external publications by the business.

2.3.3 External Seminar Hosting (Attendance) may include the number of hours of times the number attending an external seminar.

2.3.4 Work Being Done by Academic Bodies may include the dollar value of work being done by academic bodies for the business.

2.4 Delivery to Market

2.4.1 Capabilities to Market may include the number of capabilities that emerge in the marketplace per period.

2.4.2 Services Sold <2 years old may include the total number of services sold within the last two years.

2.4.3 Time to Market may include the amount of time from concept initiation to availability in the marketplace for a product or process.

2.4.4 Investment in own R&D may include the dollar amount spent on research and development divided by the total expenses for the business.

3.0 Process Capital 50 Metrics

3.1 Internal Investment

3.1.1 Investment in Internal Structures may include the total investment in new subsidiaries, methods, and systems divided by total revenues.

3.1.2 Benefits Attributable to Internal Projects may include the dollar value of the actual benefits received by the business as a result of the internal project.

3.1.4 Spend on Internal IT Systems may include the total spent on IT systems divided by total costs of the business.

3.1.5 Spend on Knowledge Sharing Facilities may include the costs attributable to making knowledge available to other staff divided by the total costs of the business.

3.2 Business Improvement

3.2.1 Improvement Suggestions may include the number of improvements suggested by the staff.

3.2.2 Improvement Suggestions Implemented may include the number of improvements suggestions implemented divided by the number of improvements suggested by the staff.

3.3 Collaboration

3.3.1 Time Saved by Leveraging may include the amount of time saved by customers using leveraged projects divided by the total amount of customers.

3.3.2 Time to Market may include the amount of time from concept initiation to availability in the marketplace for a product or process.

3.3.3 Number of Processes Leveraged may include the number of methods transferred from one customer to another.

3.3.4 Number of Projects Leveraged may include the number of projects transferred from one customer to another.

3.3.5 Knowledge Bank may include the value of the business's research, skills, customer lists, and other banks of knowledge.

3.3.6 Potential Cost Savings from Shared Information may include the previous period's usage of shared data.

3.3.7 Potential Increases in Revenue from Shared Information may include the total man hours saved times the value added per professional.

3.4 Tools Support

3.4.1 Volume of Email Passed Around the Company may include the megabytes of email data passed internally.

3.4.2 Number of Different Facilities Used to Access Information may include the total number of systems that are used to hold data.

3.4.3 Tool Availability for Staff may include the number of staff that have the tools available to do their job divided by the total number of employees.

3.4.4 Intranet Accessibility may include the percentage of employees with access to the business's intranet.

3.5 Information Sharing

3.5.1 Potential Cost Savings from Shared Information may include the previous period's usage of shared data.

3.5.2 Information Availability for Staff may include the number of staff that have the information available to do their job divided by the total number of employees.

3.5.3 Completed Documents for Repository may include the numbers of overviews of projects divided by sales opportunities.

3.5.4 Knowledge Sharer Performance may include a poll of mentees concerning the ability of their respective mentors to pass on knowledge.

3.5.5 Documented Processes may include the number of processes of the business that are detailed in specifications.

3.5.6 Documented Templates Available for Sharing may include the number of templates available to staff.

3.6 Delivery Speed and Quality

3.6.1 Number of Processes with Reduced Cycle Time may include the number of processes in which the cycle time has diminished over a period of time.

3.6.2 Rate of Defective Deliverables Provided to Customers may include the number of defects identified in products delivered to customers divided by total number of products delivered.

3.6.3 Time Taken to Resolve a Customer Problem may include the average number of time taken to resolve one customer's problems.

3.6.4 Time Taken to Locate a Resource may include the average time taken to locate a staff member.

3.6.5 Customer Problem Resolution may include the number of problems resolved divided by the total number of problems.

3.6.6 Time Taken to Resolve Customer Problems may include the average number of time taken to resolve all customer problems.

3.7 Others

3.7.1 Working Capital Turns may include the receivables plus inventory minus payables, all divided by a number of periods.

3.7.2 Too Many Chiefs may include the total number of revenues divided by administration costs.

3.7.3 Organizational Knowledge Status Survey may include a poll of staff to determine the present status of the staff's education in a competency group.

3.7.4 Knowledge Management Scorecard may include a poll of management on the status of the business's knowledge banks.

4.0 Supplied Capital Metrics

4.1 Satisfied Supplier Index may include the number of satisfied suppliers divided by the total number of suppliers.

4.2 Customer Satisfaction with Suppliers may include a poll of customers to determine their satisfaction with suppliers.

4.3 Satisfaction with Supplier may include the business's satisfaction with the supplier.

4.4 Success in Leveraging Internal Suppliers to External Markets may include the success in providing business to the business's suppliers through the business's customers.

5.0 Customer Capital 60 Metrics

5.1 Customer Capabilities

5.1.1 Number of Organization Enhancing Customers may include the number of customers providing projects over a period.

5.1.2 Value of Organization Enhancing Customers may include the value of projects given by customers over a period.

5.1.3 Number of Staff Competence Enhancing Customers may include the number of customers that provide projects expanding staff experience.

5.1.4 Number of Competence Enhancing Customers may include a poll of staff to determine their view of customer's enhancement of the staff's experience.

5.1.5 Number of Image Enhancing Customers may include the number of customers that benefit the business's trademark recognition or market analysis rating.

5.1.6 Customer Spend on Staff Competence may include the total amount provided by customers for their own projects, including man hours and dollars.

5.2 Customer Relationships

5.2.1 Win/Loss Index may include the number of successful bids for new business divided the total number of bids for new business.

5.2.2 Customer Spend with Business may include figures for each customer as to how much of their period spending was the business or business unit and it's competitors.

5.2.3 Referencability may include the number of customers willing to refer the business to potential customers.

5.2.4 Proportion of Large Customers may include a ratio of the total of billings from top ten customers divided by the total billings.

5.2.5 Longevity of Customers may include the length of an ongoing relationship with customers in months divided by the total number of customers.

5.2.6 Frequency of Repeat Orders may include the number of customers that provide repeat business divided by the total number of customers.

5.2.7 Value of Repeat Orders may include the total value of orders from repeat customers divided by the total value of orders.

5.2.8 Devoted Customers Ratio may include the number of customers with dealings with the business over five years divided by the total number of customers.

5.2.9 Profitability per Customer may include the profit per customer or profit divided by the total number of customers.

5.2.10 Contract Renewals may include the number of contracts renewed divided total number of contracts up for renewal.

5.2.11 Contract Terminations may include the number of contracts terminated early and the number of contracts not renewed divided by the total number of contracts.

5.2.12 Employees/Customers may include the number of employees divided by the total number of customers.

5.2.13 Time Spent Interfacing with Customer may include the total number of hours that staff spend communicating with the customer for a period.

5.3 Customer Satisfaction

5.3.1 Satisfied Customer Index may include the total number of satisfied customers divided by the total number of customers.

5.3.2 Number of Customer Visits to Company may include the total number of times that a customer or client visits the business's sites.

5.3.3 New Customer Site Reports may include the total number of potential customer visits.

5.3.4 Rate of Defective Deliverables Provided to the Customer may include the total number of deliverables with problems divided by the total number of deliverables.

5.3.5 Customer Problem Resolution may include the total number of problems that a customer has divided by the total number of problems for all customers.

5.3.6 Time Taken to Resolve Customer Problems may include the median time taken to solve customer issues.

6.0 Partner Capital 65 Metrics

6.1 Partner Satisfaction Index may include a poll of satisfaction given to the partners of the business.

6.2 Satisfaction with Partner may include the business's satisfaction with the partner.

6.3 Competence Enhancing Partners may include the amount of work given to the business by the partnership.

7.0 Image Capital Metrics

7.1 Image in Community may include a poll of the community to determine their views on the business.

7.2 Market Analyst Ratings may include the current market analysis rating for the business.

7.3 Knowledge & Experience in Your Industry may include the total number of years spent by staff working in the current competency group.

7.4 White Papers Published may include the total number of white papers published in a period.

7.5 Attendance at External Seminars may include the total number of hours attending external seminars divided by the total number of employees.

7.6 Number of Image Enhancing Customers may include the number of customers that benefit the business's trademark recognition or market analysis rating.

7.7 External Seminar Hosting may include the number of hours of times the number attending an external seminar

7.8 Industry Recognition Awards may include the total number of industry recognition awards given to the staff of the business.

In one embodiment, Human Capital 30 may be quantified using the following formula:

Human Capital 30=((((Average Salary for a Staff Member×Years Experience factor)×Staff Satisfaction factor)×Staff Turnover Rate)×Number of Professionals in Organization)+Knowledge Bank value+Training Investment

It will be understood that the Human Capital 30 calculation may include none, one, some or all of the metrics used in the above exemplary calculation to determine the value of Human Capital. Other metrics used by the business might include “Relative Pay Position,” which is the ratio of staff pay to outside pay, and “Experience in Competency Type,” which is the total number of years in a business unit for all staff of the business.

In one embodiment, a value might be assigned Structural Capital 35 by summing Innovation Capital 45 and Process Capital 50. For example, to obtain a dollar value for Innovation Capital 45, the business might obtain the dollar value of its patents, or the “Value of Patents” metric. Then, the business may sum the three Process Capital 50 categories of “Internal Investment,” “Collaboration,” and “Information Sharing” and combinations result with the value for Innovation Capital 45.

In one embodiment, a value might be assigned to the External Capital 40 by determining the Customer Capital 60 dollar value, converting the other three capital figures (represented under External Capital 40 in FIG. 2) to percentages, and multiplying the dollar value by these percentages. This provides an External Capital 40 value that may have started as the Average Customer Spend per Annum. The figure may have then been reduced by applying (in effect) percentages where customers are not totally satisfied, not willing to provide references, image of the business in the community is not perfect, or any other customer satisfaction criteria. In another embodiment, the Customer Capital 60 dollar value may be the value of ongoing customer relationships multiplied by the ratio of devoted customers multiplied by the percentage of contract renewals.

FIG. 3 illustrates a method for measuring Intellectual Capital 25 in accordance with one embodiment of the present invention. In this embodiment, radar diagram 300 includes a plurality of scaled axes 320 to 350 originating from center point 305. For exemplary purposes only, the scales are represented for value 50 at line 310 and value 100 at line 315.

Each scaled axis comprises a metric that has been measured and quantified. Each quantified metric might then be scaled in relation to the other measured metrics. For example, scaled axis 320 may represent a median age of staff, scaled axis 325 may represent a number of mentored staff, scaled axis 330 may represent staff retention rate, scaled axis 335 may represent education level, scaled axis 340 may represent absenteeism rate, scaled axis 345 may represent an overall attitude of staff, and scaled axis 350 may represent a dollar amount spent on training the staff. The exemplary metrics might be measured and quantified in differing manners. For example, scaled axis 340 may be a ratio of median days at work and total work days, while scaled axis 350 may be a dollar amount. Therefore, each axis is scaled so that it may be represented as a value similar to the other quantified metrics. Once the axes are scaled, the respective value for each axis is plotted. For example, point 355 may represent the scaled median age of the staff, along the appropriate axis.

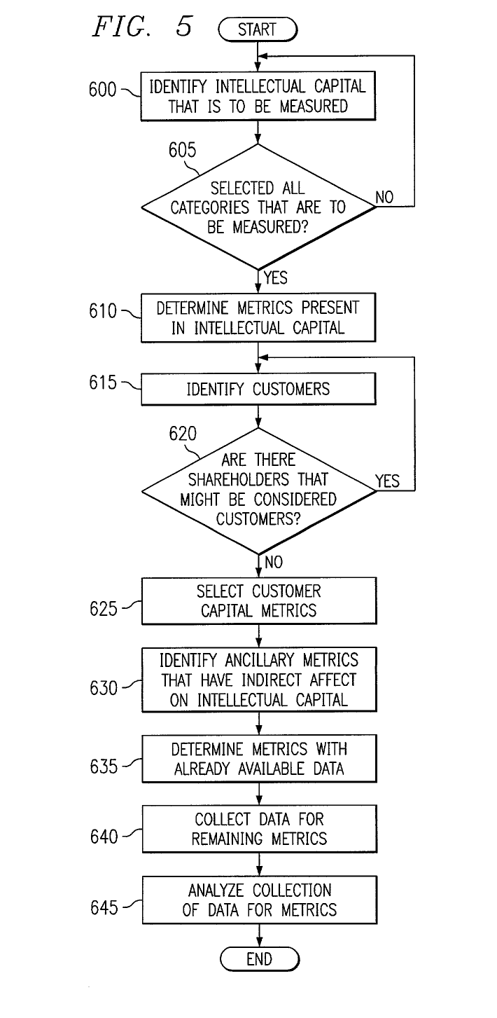

FIG. 4 further illustrates the radar diagram 300 of FIG. 3 measuring Intellectual Capital 25 in accordance with one embodiment of the present invention. Once all of the points 355 to 385 are plotted on the respective scaled axes, the Intellectual Capital 25 may be quantified. In this embodiment, a line 390 connects each point 355 to 385, resulting in an inner region 395. An area of region 395 is then computed. The area of region 395 provides the business or business unit a value of the quantified Intellectual Capital 25 and the ability to monitor changes in the Intellectual Capital 25. For example, if the education level of a business's staff rises, the point 370 moves outwardly along scaled axis 335 causing the area of region 395 to increase. This may represent a rise in the worth of the business's Human Capital 30.

FIG. 5 is a flow diagram illustrating a method for measuring Intellectual Capital in accordance with one embodiment of the present invention. At step 600, the key functionality should be examined for the business or business unit. For example, a business that relies on delivering facilities to their customers (e.g. oil or gas industries) might feel that the areas of Structural Capital will be of most importance, while businesses that provide consulting services to their customers may determine that Human Capital is key. It also may be appropriate to select more than one capital and then identify a set of key factors from each of the capitals as important to the business or business unit. In another example, the business or business unit may produce applications, develop IS/IT infrastructure, or solve customer problems. The business may then need to measure Structural Capital (such as processes and procedures) and Human Capital (such as the experience and learning of developers).

In decisional step 605, it is determined whether all the categories that are desired are included in the one or more Intellectual Capitals identified in step 600. Furthermore, not every category of the Intellectual Capital need be measured. For example, if the identified Intellectual Capital is External Capital, then the business or business unit might measure the number of contract terminations, which is included in the Customer Capital category. However, the business may not have any suppliers. Therefore, in this example, the Supplier Capital category would not be needed.

Having defined the Intellectual Capital at step 600 and the categories to be measured at step 605, the metrics that govern the selected intellectual capitals are determined at step 610. In one embodiment, the business first identifies metrics that might influence the overall performance of the business and then selects metrics that influence the performance of the business. For example, staff turnover may be a key metric that influences the performance of a human resources department. It will be understood that there is no minimum or maximum number of metrics appropriate for the business. Each business may be different and, therefore, might identify and select different metrics.

At step 615, the business identifies its customers. The customers might include clients of the business, other internal departments, and governmental entities. Stakeholders within the business might also be considered customers. Thus, at step 620, the business might determine that one or more shareholders are customers for the purpose of determining the value of the identified Intellectual Capitals. Even an internal client might be a customer to the business or business unit. For example, one customer might be the business itself, as it will increase Customer Capital by delivering quality services, on time and under budget. This might result in satisfied customers who will renew contracts, provide more challenging assignments, and increase spending with the business. If the shareholder might be considered a customer, then the method returns to step 615. Otherwise, it proceeds to step 625.

The list of Customer Capital metrics that were selected in step 610, if any, are refined at step 625 to adequately reflect a value based on the selected customers and shareholders. Next, at step 630, any remaining ancillary metrics are selected. An ancillary metric might be any metric that has an indirect effect on the identified Intellectual Capital. For example, if the business wants to extend the capability of it's staff then it may want to focus on particular customers to provide a challenge and develop the business further.

At step 635, the business considers what data is available. The available data is then applied to the appropriate selected metrics. Next, data is collected to suitably quantify the remaining metrics at step 640. Once the metrics have been quantified, the business may analyze the collection of selected metrics and determine an overall value for the identified Intellectual Capital.

Although the present invention has been described in detail, it should be understood that various changes, substitutions and alterations can be made hereto without departing from the sphere and scope of the invention as defined by the appended claims.

To aid the Patent Office, and any readers of any patent issued on this application in interpreting the claims appended hereto, applicants wish to note that they do not intend any of the appended claims to invoke ¶ 6 of 35 U.S.C. § 112 as it exists on the date of filing hereof unless “means for” or “step for” are used in the particular claim.

What is claimed is:

1. A method for measuring intellectual capital comprising:
identifying one or more intellectual capitals to be measured, wherein the intellectual capital comprises human capital, structural capital, and external capital;
selecting a set of metrics that are present within the identified intellectual capitals, wherein the set of metrics comprises one or more monetary metrics and one or more non-monetary metrics;
assigning values to the set of selected metrics;
scaling the set of valued metrics, wherein the scaled non-monetary metrics and monetary metrics are operable to be mathematically associated; and
quantifying the identified intellectual capitals based on the scaled metrics.

2. The method of claim 1, wherein the human capital is determined based on a plurality of parameters, including one or more of the following:
competency information;
performance of staff;
training and education of the staff;
attitudes of the staff;
usage of contractors; and
experience of staff.

3. The method of claim 1, wherein the structural capital comprises innovation capital and process capital.

4. The method of claim 3, wherein the innovation capital is determined based on a plurality of parameters, including one or more of the following:
internal communications regarding inventions;
external communications regarding the inventions;
patent protection; and
delivery to market of products or services embodying the inventions.

5. The method of claim 3, wherein the process capital is determined based on a plurality of parameters, including one or more of the following:
internal investment;
business improvement;
collaboration among staff;
support tools for the staff;
information sharing; and
speed and quality of deliveries.

6. The method of claim 1, wherein the external capital comprises supplier capital, customer capital, partner capital, and image in market.

7. The method of claim 6, wherein the supplier capital is determined based on a plurality of parameters, including one or more of the following:
a satisfied supplier index;
success in leveraging internal suppliers to external markets; and
customer satisfaction with suppliers.

8. The method of claim 6, wherein the customer capital is determined based on a plurality of parameters, including one or more of the following:
capabilities of customers;
relationships with the customers; and
satisfaction of the customers.

9. The method of claim 6, wherein the partner capital is determined based on a plurality of parameters, including one or more of the following:
a partner satisfaction index;
customer satisfaction with a partner; and
competence enhancing partners.

10. The method of claim 6, wherein the image in market is determined based on a plurality of parameters, including one or more of the following:
image in a community;
market analysis ratings;
white papers published;
attendance at external seminars;
hosting of the external seminars; and
industry recognition awards.

11. The method of claim 1 further comprising defining the relationship between financial capital and the intellectual capital.

12. The method of claim 1 further comprising creating a radar diagram, wherein the radar diagram comprises:
a plurality of scaled axes, wherein each scaled axis represents one of the metrics present in the intellectual capital; and
a point on each axis to represent the quantified metric.

13. The method of claim 12, wherein quantifying the identified intellectual capitals based on the scaled metrics comprises determining the total area enclosed in the radar diagram.

14. The method of claim 2, wherein the competency information is determined based on a plurality of metrics, including one or more of the following:
experience in a competency type; and
experience of workforce.

15. The method of claim 2, wherein the performance of staff is determined based on a plurality of metrics, including one or more of the following:
turnover;
median age of staff in organization;
succession planning;
revenue generating staff/efficiency of organization;
internal grading;
professional internal grading;
timely appraisals;
number of days absenteeism;
mentored staff;
social network mapping;
knowledge sharer performance; and
leverage effect.

16. The method of claim 2, wherein the training and education of the staff is determined based on a plurality of metrics, including one or more of the following:
training investment;
education level per staff member; and
training provided.

17. The method of claim 2, wherein the usage of contractors is determined based on a plurality of metrics, including one or more of the following:
revenue generating staff/efficiency of organization;
time not spent on productive work; and
value added per staff member.

18. The method of claim 4, wherein the internal communications regarding inventions is determined based on a plurality of metrics, including one or more of the following:
best practice shared;
usage of best practices;
usage of a piece of knowledge;
new ideas generated; and
white papers published.

19. The method of claim 4, wherein the patent protection regarding inventions is determined based on a plurality of metrics, including one or more of the following:
number of patents owned;
value of patents owned; and
number of patents proposed.

20. The method of claim 4, wherein the external communications regarding inventions is determined based on a plurality of metrics, including one or more of the following:
published internal achievements;
words in print;
external seminar hosting; and
work being done by academic bodies.

21. The method of claim 4, wherein the delivery to market of products or services embodying the inventions is determined based on a plurality of metrics, including one or more of the following:
capabilities to market;
services sold;
time to market; and
investment in own research and development.

22. The method of claim 5, wherein the internal investment is determined based on a plurality of metrics, including one or more of the following:
investment in internal structures;
benefits attributable to internal projects;
spend on internal IT systems; and
spend on knowledge sharing facilities.

23. The method of claim 5, wherein the business improvement is determined based on a plurality of metrics, including one or more of the following:
improvement suggestions; and
improvement suggestions implemented.

24. The method of claim 5, wherein the collaboration among staff is determined based on a plurality of metrics; including one or more of the following:
time saved by leveraging;
time to market;
number of processes leveraged;
number of projects leveraged;
knowledge bank;
potential cost savings from shared information; and
potential increases in revenue from shared information.

25. The method of claim 5, wherein the support tools for the staff is determined based on a plurality of metrics, including one or more of the following:
volume of Email passed around the company;
intranet accessibility;
number of different facilities used to access information; and
tool availability for staff.

26. The method of claim 5, wherein the information sharing is determined based on a plurality of metrics, including one or more of the following:
potential cost savings from shared information;
information availability for staff;
completed documents for repository;
knowledge sharer performance;
documented processes; and
documented templates available for sharing.

27. The method of claim 5, wherein the speed and quality of deliveries is determined based on a plurality of metrics, including one or more of the following:
delivery speed and quality;
number of processes with reduced cycle time;
rate of defective deliverables provided to customers;
time taken to resolve a customer problem;
customer problem resolution;
time taken to resolve customer problems; and
time taken to locate a resource.

28. The method of claim 8, wherein the capabilities of the customers is determined based on a plurality of metrics, including one or more of the following:
number of organization enhancing customers;
value of organization enhancing customers;
number of staff competence enhancing customers;
number of competence enhancing customers;
number of image enhancing customers;
customer spend on staff competence; and enhancing projects.

29. The method of claim 8, wherein the relationships with the customers is determined based on a plurality of metrics, including one or more of the following:
win/loss index;
customer spend with business;
referencability;
proportion of large customers;
longevity of customers;
frequency of repeat orders;
value of repeat orders;
devoted customers ratio;
profitability per customer;
contract renewals;
contract terminations;
number of staff per customer; and
time spent interfacing with customer.

30. The method of claim 8, wherein the satisfaction of the customers is determined based on a plurality of metrics, including one or more of the following:
satisfied customer index;
number of customer visits to company;
new customer site reports;
rate of defective deliverables provided to the customer;
customer problem resolution; and
time taken to resolve customer problems.

31. A balance sheet for measuring intellectual capital comprising:
a list of metrics operable to value one or more intellectual capitals, wherein the intellectual capital comprises human capital, structural capital, and external capital and the set of metrics comprises one or more monetary metrics and one or more non-monetary metrics;
a set of algorithms operable to scale the metrics, wherein the scaled non-monetary metrics and monetary metrics are operable to be mathematically associated;;
a set of mathematical calculations operable to associate the scaled metrics and further operable to quantify the intellectual capitals based on the associated metrics; and
a management view of the quantified intellectual capitals.

32. The balance sheet of claim 31, wherein the human capital is determined based on a plurality of parameters, including one or more of the following:
competency information;
performance of staff;
training and education of the staff;
attitudes of the staff;
usage of contractors; and
experience of staff.

33. The balance sheet of claim 31, wherein the structural capital comprises innovation capital and process capital.

34. The balance sheet of claim 33, wherein the innovation capital is determined based on a plurality of parameters, including one or more of the following:
internal communications regarding inventions;
external communications regarding the inventions;
patent protection; and
delivery to market of products or services embodying the inventions.

35. The balance sheet of claim 33, wherein the process capital is determined based on a plurality of parameters, including one or more of the following:
internal investment;
business improvement;
collaboration among staff;
support tools for the staff;
information sharing; and
speed and quality of deliveries.

36. The balance sheet of claim 31, wherein the external capital comprises supplier capital, customer capital, partner capital, and image in market.

37. The balance sheet of claim 36, wherein the supplier capital is determined based on a plurality of parameters, including one or more of the following:
a satisfied supplier index;
success in leveraging internal suppliers to external markets; and
customer satisfaction with suppliers.

38. The balance sheet of claim 36, wherein the customer capital is determined based on a plurality of parameters, including one or more of the following:
capabilities of customers;
relationships with the customers; and
satisfaction of the customers.

39. The balance sheet of claim 36, wherein the partner capital is determined based on a plurality of parameters, including one or more of the following:
a partner satisfaction index;
customer satisfaction with a partner; and
competence enhancing partners.

40. The balance sheet of claim 36, wherein the image in market is determined based on a plurality of parameters, including one or more of the following:
image in a community;
market analysis ratings;
white papers published;
attendance at external seminars;
hosting of the external seminars; and
industry recognition awards.

41. The balance sheet of claim 31, wherein the management view of the quantified intellectual capitals comprises a radar diagram, wherein the radar diagram comprises:
a plurality of scaled axes, wherein each scaled axis represents one of the metrics present in the relationship; and
a point on each axis to represent the value associated with the metric.

42. The balance sheet of 41, wherein the set of mathematical calculations operable to associate the scaled metrics and further operable to quantify the intellectual capitals based on the associated metrics comprises determining the total area enclosed in the radar diagram.

43. The balance sheet of claim 32, wherein the competency information is determined based on a plurality of metrics, including one or more of the following:
experience in a competency type, and
experience of workforce.

44. The balance sheet of claim 32, wherein the performance of staff is determined based on a plurality of metrics, including one or more of the following:
turnover;
median age of staff in organization;
succession planning;
revenue generating staff/efficiency of organization;
internal grading;
professional internal grading;
timely appraisals;
number of days absenteeism;
mentored staff;
social network mapping;
knowledge sharer performance; and
leverage effect.

45. The balance sheet of claim 32, wherein the training and education of the staff is determined based on a plurality of metrics, including one or more of the following:
training investment;
education level per staff member; and
training provided.

46. The balance sheet of claim 32, wherein the usage of contractors is determined based on a plurality of metrics, including one or more of the following:
revenue generating staff/efficiency of organization;
time not spent on productive work; and
value added per staff member.

47. The balance sheet of claim 34, wherein the internal communications regarding inventions is determined based on a plurality of metrics, including one or more of the following:
best practice shared;
usage of best practices;
usage of a piece of knowledge;
new ideas generated; and
white papers published.

48. The balance sheet of claim 34, wherein the patent protection regarding inventions is determined based on a plurality of metrics, including one or more of the following:
number of patents owned;
value of patents owned; and
number of patents proposed.

49. The balance sheet of claim 34, wherein the external communications regarding inventions is determined based on a plurality of metrics, including one or more of the following:
published internal achievements;
words in print;
external seminar hosting; and
work being done by academic bodies.

50. The balance sheet of claim 34, wherein the delivery to market of products or services embodying the inventions is determined based on a plurality of metrics, including one or more of the following:
capabilities to market;
services sold;
time to market; and
investment in own research and development.

51. The balance sheet of claim 35, wherein the internal investment is determined based on a plurality of metrics, including one or more of the following:
investment in internal structures;
benefits attributable to internal projects;
spend on internal IT systems; and
spend on knowledge sharing facilities.

52. The balance sheet of claim 35, wherein the business improvement is determined based on a plurality of metrics, including one or more of the following:
improvement suggestions; and
improvement suggestions implemented.

53. The balance sheet of claim 35, wherein the collaboration among staff is determined based on a plurality of metrics, including one or more of the following:
time saved by leveraging;
time to market;
number of processes leveraged;
number of projects leveraged;
knowledge bank;
potential cost savings from shared information; and
potential increases in revenue from shared information.

54. The balance sheet of claim 35, wherein the support tools for the staff is determined based on a plurality of metrics, including one or more of the following:
volume of Email passed around the company;
intranet accessibility;
number of different facilities used to access information; and
tool availability for staff.

55. The balance sheet of claim 35, wherein the information sharing is determined based on a plurality of metrics, including one or more of the following:
potential cost savings from shared information;
information availability for staff;
completed documents for repository;
knowledge sharer performance;
documented processes; and
documented templates available for sharing.

56. The balance sheet of claim 35, wherein the speed and quality of deliveries is determined based on a plurality of metrics, including one or more of the following:
delivery speed and quality;
number of processes with reduced cycle time;
rate of defective deliverables provided to customers;
time taken to resolve a customer problem;
customer problem resolution;
time taken to resolve customer problems; and
time taken to locate a resource.

57. The balance sheet of claim 38, wherein the capabilities of the customers is determined based on a plurality of metrics, including one or more of the following:
number of organization enhancing customers;
value of organization enhancing customers;
number of staff competence enhancing customers;
number of competence enhancing customers;
number of image enhancing customers;
customer spend on staff competence; and
enhancing projects.

58. The balance sheet of claim 38, wherein the relationships with the customers is determined based on a plurality of metrics, including one or more of the following:
win/loss index;
customer spend with business;
referencability;
proportion of large customers;
longevity of customers;
frequency of repeat orders;
value of repeat orders;
devoted customers ratio;
profitability per customer;
contract renewals;
contract terminations;
number of staff per customer; and
time spent interfacing with customer.

59. The balance sheet of claim 38, wherein the satisfaction of the customers is determined based on a plurality of metrics, including one or more of the following:
satisfied customer index;
number of customer visits to company;
new customer site reports;
rate of defective deliverables provided to the customer;
customer problem resolution; and
time taken to resolve customer problems.
